(19) United States
(12) Patent Application Publication
(10) Pub. No.: US 2022/0225813 A1
(43) Pub. Date: Jul. 21, 2022

(54) SPLIT CURTAIN HAVING MAGNETS ALONG THE LEADING EDGES TO PROVIDE IMPROVED CLOSURE AND/OR IN A ROW TO PROVIDE IMPROVED STACKING

(71) Applicant: E & E Co., Ltd., Fremont, CA (US)

(72) Inventor: Bruce Garfinkel, Woodmere, NY (US)

(73) Assignee: E & E Co., Ltd., Fremont, CA (US)

(21) Appl. No.: 17/154,932

(22) Filed: Jan. 21, 2021

(51) Int. Cl. A47H 23/01; A47H 23/10

(52) U.S. Cl. CPC A47H 23/01; A47H 23/10

(57) ABSTRACT

A split curtain comprises a left panel having a left head portion configured to cooperate with a supporting structure and having a left leading edge; a right panel having a right head portion configured to cooperate with the supporting structure and having a right leading edge; a plurality of left magnets disposed along the left leading edge of the left panel at left vertical positions; and a plurality of right magnets disposed along the right leading edge of the right panel at right vertical positions, the right vertical positions being substantially the same as the left vertical positions.

### TECHNICAL FIELD

This invention relates generally to curtains, and more particularly provides a split curtain having magnets at least along the leading edges to provide improved closure and/or in a row to provide improved stacking.

### BACKGROUND

Curtains and/or drapes are often used to cover a window or doorway to provide privacy and/or darkness to a room, such as a bedroom or living room. When using a split curtain and/or drape, a gap between the adjacent panels can disturb the quiet enjoyment of the room, either by causing loss of privacy or by allowing the light to interfere.

### SUMMARY

In accordance with some embodiments, the present invention provides a split curtain, comprising a left panel having a left head portion configured to cooperate with a supporting structure and having a left leading edge; a right panel having a right head portion configured to cooperate with the supporting structure and having a right leading edge; a plurality of left magnets disposed along the left leading edge of the left panel at left vertical positions; and a plurality of right magnets disposed along the right leading edge of the right panel at right vertical positions, the right vertical positions being substantially the same as the left vertical positions.

The plurality of left magnets and the plurality of right magnets may be spaced apart by approximately 11″. Each of the left magnets and each of the right magnets may be disposed within an enclosure. The enclosure may be made of plastic. The enclosure may be water tight. The enclosure may include a pocket. The pocket may include a retention structure. The left head portion and the right head portion may be parts of the same fabric. The left head portion and the right head portion may be individual portions. The split curtain may further comprise a third panel having a third head portion, a third leading edge, and a plurality of third magnets disposed along the third leading edge, the third leading edge configured to cooperate with a second leading edge of the right panel, the right panel further having a plurality of second magnets disposed along the second leading edge. The left panel may include a plurality of magnets on a second edge opposite the left leading edge, and the right panel may include a plurality of magnets on a second edge opposite the right leading edge.

In accordance with some embodiments, the present invention provides a method, comprising maneuvering a left panel and a right panel to bring a left leading edge of the left panel into contact with a right leading edge of the right panel, the left panel having a left head portion configured to cooperate with a supporting structure and having a plurality of left magnets disposed along the left leading edge at left vertical positions, the right panel having a right head portion configured to cooperate with the supporting structure and having a plurality of right magnets disposed along the right leading edge at right vertical positions, the right vertical positions being substantially the same as the left vertical positions; and maneuvering the plurality of left magnets of the left panel at the left vertical positions to contact the plurality of right magnets of the right panel at the right vertical positions, so that the plurality of left magnets engage with the plurality of right magnets.

In accordance with some embodiments, the present invention provides a method comprising affixing a plurality of left magnets to a left leading edge of a left panel at left vertical positions, the left panel having a left head portion configured to cooperate with a supporting structure; and affixing a plurality of right magnets to a right leading edge of a right panel at right vertical positions, the right vertical positions being substantially the same as the left vertical positions, the left panel having a right head portion configured to cooperate with the supporting structure.

The plurality of left magnets and the plurality of right magnets may be spaced apart by approximately 11″. Each of the left magnets and each of the right magnets may be disposed within an enclosure. The enclosure may be made of plastic. The enclosure may be water tight. The enclosure may include a pocket. The pocket may include a retention structure. The left head portion and the right head portion may be parts of the same fabric. The left head portion and the right head portion may be individual portions. The method may further comprise attaching a plurality of third magnets along a third leading edge of a third panel having a third head portion; and attaching a plurality of second magnets along a second leading edge of the right panel, the third leading edge of the third panel configured to cooperate with the second leading edge of the right panel.

### BRIEF DESCRIPTION OF THE DRAWINGS

FIG. 1 illustrates a split curtain in an open position, having magnets at least disposed along the leading edges of the left and right panels, in accordance with some embodiments.

FIG. 2 illustrates a split curtain in a partially closed position, with some magnets along the leading edges of the left and right panels engaged, in accordance with some embodiments.

FIG. 3 illustrates split curtain in a partially closed position, with some magnets along the leading edges of the left and right panels engaged, in accordance with some embodiments.

FIG. 4 illustrates a split curtain in an open position, in accordance with some embodiments.

FIG. 5 illustrates a portion of the split curtain of FIG. 4 in a closed position with the magnets along the leading edges of the left and right panels engaged, in accordance with some embodiments.

FIG. 6 illustrates a portion of the split curtain of FIG. 4 in an open position, in accordance with some embodiments.

FIG. 7 illustrates a left panel of a split curtain having magnets along its leading edge, in accordance with some embodiments.

FIG. 8 illustrates a right panel of a split curtain having magnets along its leading edge, in accordance with some embodiments.

FIG. 9 illustrates a back side of a right or left panel of a split curtain, in accordance with some embodiments.

FIG. 10 illustrates a magnet, in accordance with some embodiments.

FIG. 11 illustrates an enclosure for receiving and/or enclosing a magnet, in accordance with some embodiments.

FIG. 12 illustrates a split curtain during manufacture, having magnets along the leading edges of the left and right panels, in accordance with some embodiments.

FIG. 13 illustrates a left panel of a split curtain, having magnets affixed to its leading edge, in accordance with some embodiments.

FIG. 14 illustrates a left panel of a split curtain, having magnets removably disposed in pockets affixed along its leading edge, in accordance with some embodiments.

FIG. 15 illustrates a left panel in a closed position, having magnets disposed in a row to provide improved stacking when the left panel is in an open position, in accordance with some embodiments.

FIG. 16 illustrates a left panel in an open position, having magnets disposed a row engaged, in accordance with some embodiments.

FIG. 17 illustrates bidirectional panels, in accordance with some embodiments.

### DETAILED DESCRIPTION

The following description is provided to enable a person skilled in the art to make and use various embodiments of the invention. Modifications are possible. The generic principles defined herein may be applied to the disclosed and other embodiments without departing from the spirit and scope of the invention. Thus, the claims are not intended to be limited to the embodiments disclosed, but are to be accorded the widest scope consistent with the principles, features and teachings herein.

The term “curtain” herein refers to all versions of hanging, fabric-based coverings including drapes, screens, traditional curtains, etc. A curtain herein includes coverings that extend or do not extend to the floor, coverings over a doorway, window, room portion and/or other area or item, and/or coverings made of cloth, fiberglass, plastic, screening material, sheer material, light-blocking material and/or the like. A curtain herein includes curtains with any pleat design (e.g., inverted pleats, ripple folds, tailored pleats, pinch pleats, etc.) and any head configuration (e.g., rod pocket, grommets, cubicle, goblet, etc.).

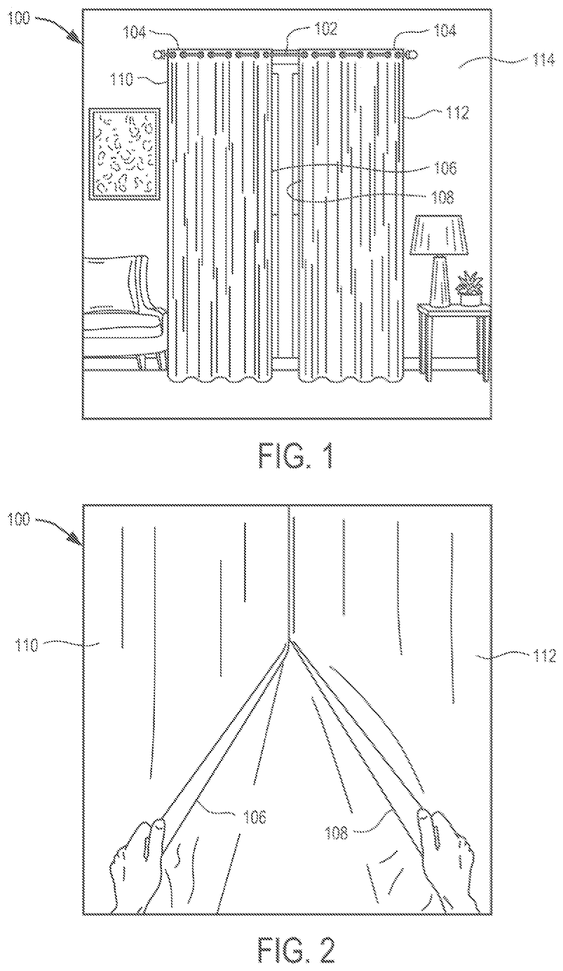

The term “split curtain” herein refers to curtains having two or more panels. The two or more panels may be maneuvered in different (e.g., opposite) directions to open or close a space between leading edges of the panels. A split curtain may include two panels, as shown in FIG. 1. Alternatively, a split curtain may include three or more panels. A split curtain may be maneuvered manually or automatically (e.g., powered).

Each panel of a split curtain includes a head portion, namely, the upper portion of the curtain that cooperates with a support structure, e.g., a rod or rail, which may be an integral device or multiple devices, and which is often attached to the wall or other surface. Each panel of a split curtain includes at least one leading edge, namely, an edge that may be maneuvered to cooperate with an adjacent panel. Split curtains having three or more panels will have middle panels with left and right leading edges that each cooperate with a different adjacent panel. Each panel of a split curtain has a front face (the face that is typically directed towards the main living space) and a rear face (the face that is typically directed away from the main living space). It will be appreciated that, in some embodiments, the front and rear face is a matter of design choice. Users may position the curtains to face either direction. It will be further appreciated that a left panel may have a “left” leading edge that is actually on the right side of the panel, and a right panel may have a “right” leading edge that is actually on the left side of the panel. A center panel will have two leading edges, namely, a center left leading edge and a center right leading edge.

A split curtain has an “open” position and a “closed” position. The open position refers to the position when the leading edges of adjacent panels have been separated. The closed position refers to the position when the leading edges of adjacent panels are brought together to block the item it is covering, e.g., door, window, closet, area, item, etc. Split curtains having three or more panels may have multiple open and closed positions between adjacent panels.

FIG. 1 illustrates a split curtain 100 in an open position, in accordance with some embodiments. The split curtain 100 includes left and right panels 110 and 112. Each of the left and right panels 110 and 112 of the split curtain 100 includes a head portion 104 that cooperates with a support structure, in this case, a rod 102 attached to the wall 114. The left and right panels 110 and 112 suspend from the rod 104. The left panel 110 includes a left leading edge 106. The right panel 112 includes a right leading edge 108. As shown, the left and right panels 110 and 112 have been maneuvered to separate the left leading edge 106 of the left panel 110 from the right leading edge 108 of the right panel 112.

The split curtain 100 includes magnets (not shown) along the left and right leading edges 106 and 108 of the left and right panels 110 and 112. The magnets positioned on the left leading edge 106 of the left panel 110 are configured to magnetically engage with the magnets on the right leading edge 108 of the right panel 112, so that the left and right leading edges 106 and 108 can create a tighter, more stable seal therebetween. When the split curtains are maneuvered to the closed position, the split curtain 100 may provide improved privacy, light-protection and/or insect protection. Further, they may not separate by a light breeze.

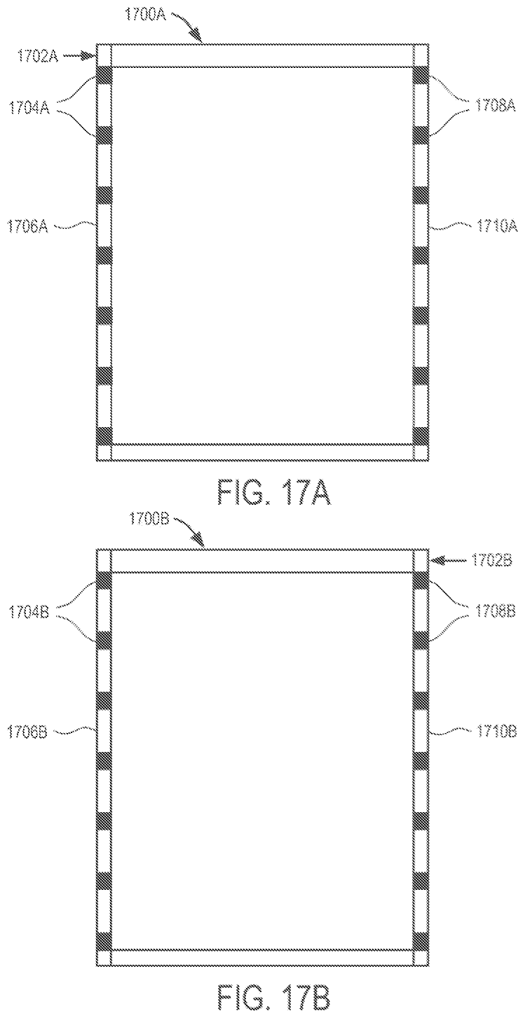

Although not shown, the left and right panels 110 and 112 may have magnets on both the left and right edges of the panel to form bidirectional panels, so that any panel can be used on the left side or on the right side, and so that any number of panels can be used. An example of bidirectional panels is shown in FIG. 17.

FIG. 2 illustrates the split curtain 100 in a partially closed position, with some magnets (not shown) engaged, in accordance with some embodiments. As shown, the upper portion of left leading edge 106 of the left panel 110 is magnetically engaged with the upper portion of the right leading edge 108 of the right panel 112. By applying a little force, a user can separate the left and right leading edges 106 and 108 and can maneuver the split curtain 100 to an open position.

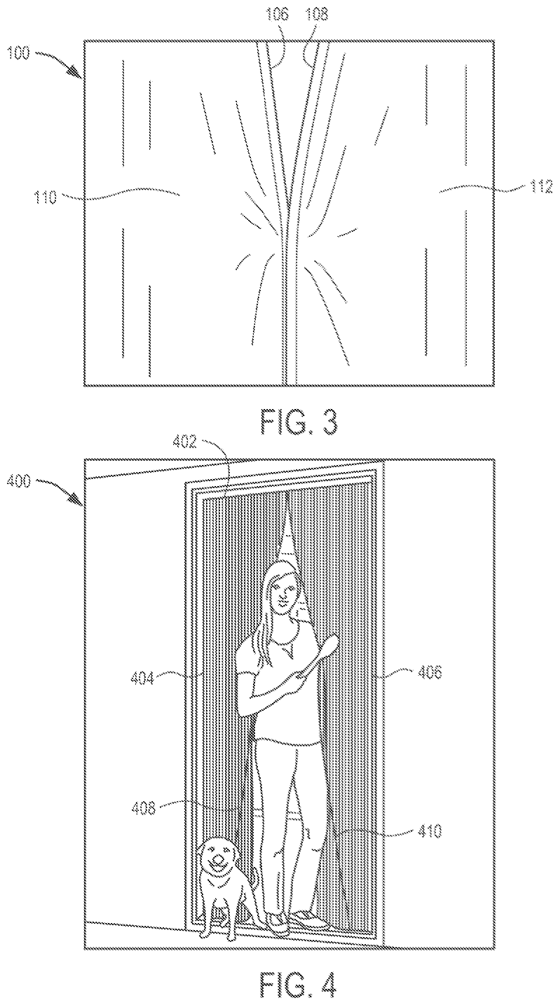

The magnets can be positioned within each of the left and right panels 110 and 112 with north and south poles facing in opposite directions. Accordingly, the left leading edge 106 and right leading edge 108 may magnetically engage by the back faces or by the front faces of the left and right panels 110 and 112, as shown in FIG. 2. As shown in FIG. 3, the magnets within each of the left and right panels 110 and 112 can be positioned with north and south poles facing the same direction. Accordingly, the left leading edge 106 and right leading edge 108 may magnetically engage in an overlapping manner, e.g., with the left leading edge 106 on top of the right leading edge 108 or with the right leading edge 108 on top of the left leading edge 106 (as shown). Magnetic pole direction may be curtain-specific or by user preference (e.g., by repositioning removable or reversible magnets within pockets).

FIG. 4 illustrates a split curtain 400 in an open position, in accordance with some embodiments. In FIG. 4, the split curtain 400 includes a screen-type material and is being used as a screen door. The split curtain 400 includes an integral, fixed head portion 402 across the entire split curtain 400. That is, the integral, fixed head portion 402 does not allow the head portion 402 of the left panel 404 to be maneuvered away from head portion 402 of the right panel 406. In some embodiments, the head portion 402 may be formed from a single piece of fabric. In some embodiments, the head portion 402 of the left panel 404 may be sewn together with the head portion 402 of the right panel 406. In some embodiments, the head portion 402 of the left panel 404 may be removably disengaged from the head portion 402 of the right panel 406, e.g., by a button or hook-and-loop fastener.

The split curtain 400 includes magnets (not shown) at least along the left and right leading edges 408 and 410 of the left and right panels 404 and 406. When in the closed position, the split curtain 400 may provide improved insect protection. A person can separate the left and right leading edges 408 and 410 of the left and right panels 404 and 406 to pass through the split curtain 400, and after passing through can position the left and right leading edges 408 and 410 back together to cause the magnets to reengage.

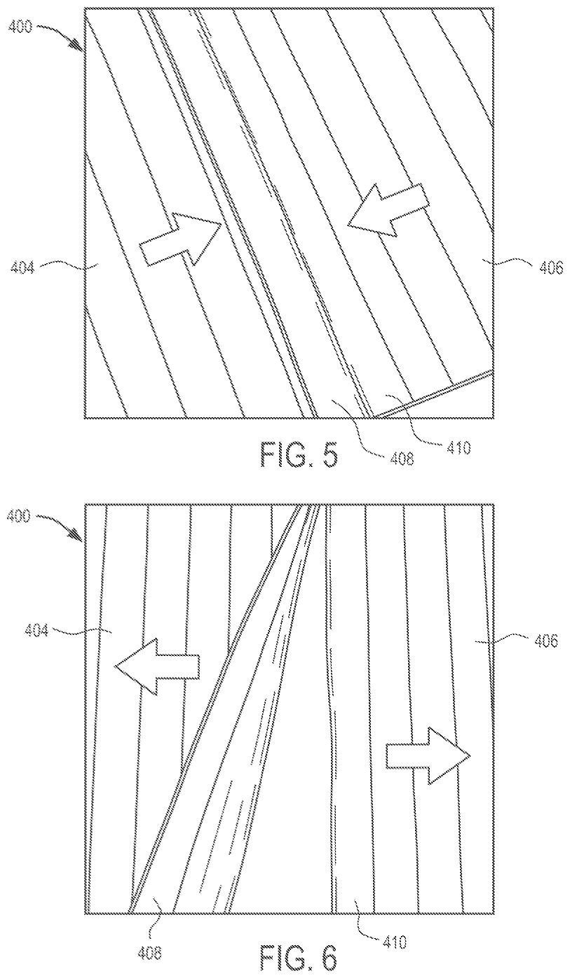

FIG. 5 illustrates a portion of the split curtain 400 in a closed position, with the magnets (not shown) along the left and right leading edges 408 and 410 of the left and right panels 404 and 406 engaged, in accordance with some embodiments.

FIG. 6 illustrates a portion of the split curtain 400 in an open position, with the magnets (not shown) along the left and right leading edges 408 and 410 of the left and right panels 404 and 406 disengaged, in accordance with some embodiments.

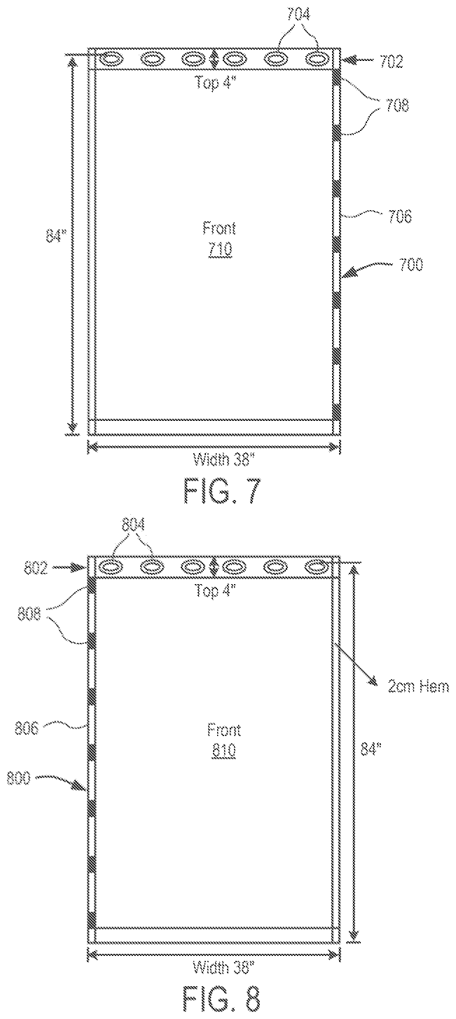

FIG. 7 illustrates a left panel 700 of a split curtain, in accordance with some embodiments. The dimensions of the left panel 700 as shown are 84″ tall by 38″ wide, although any other dimensions are possible. The left panel 700 includes a head portion 702 that includes grommets 704 configured to cooperate with a supporting structure, e.g., rod 102. The dimension of the head portion 702 as shown is 4″ tall, although any other dimension is possible. The left panel 700 includes a front face 710 and a left leading edge 706. As shown, the left leading edge 706 is equipped with seven magnets 708, equally spaced along the left leading edge 706, although any number of magnets 708 is possible. The top magnet 708 is positioned directly below the head portion 702. The bottom magnet 708 is positioned above a bottom hem, which may be 2″ tall, although any other dimension is possible. Based on the dimensions of the example panel of FIG. 7, each magnet 708 is spaced apart by approximately 11″-13″. In other embodiments, the number of magnets 706 and space therebetween may be different, e.g., approximately 11″. For example, there could be as few as one magnet 706, perhaps positioned at the vertical center of a leading edge. There could be two magnets, one positioned at the vertical center and one at the bottom. There could be any number of magnets 708 so that they are spaced apart at a greater or lower distance.

FIG. 8 illustrates a right panel 800 of a split curtain, in accordance with some embodiments. The dimensions of the right panel 800 as shown are 84″ tall by 38″ wide, although any other dimensions are possible. The right panel 800 includes a head portion 802 that includes grommets 804 configured to cooperate with a supporting structure, e.g., rod 102. The dimension of the head portion 802 as shown is 4″ tall, although any other dimension is possible. The right panel 800 includes a front face 810 and a right leading edge 806. As shown, the right leading edge 806 is equipped with seven magnets 808, equally spaced along the right leading edge 806, although any number of magnets 808 is possible. The top magnet 808 is positioned directly below the head portion 802. The bottom magnet 808 is positioned above a bottom hem, which may be 2″ tall, although any other dimension is possible. Based on the dimensions of the example panel of FIG. 8, each magnet 808 is shown to be spaced apart approximately 11-13″. In other embodiments, the number of magnets 806 and space therebetween may be different, e.g., approximately 11″. For example, there could be as few as one magnet 806, perhaps positioned at the vertical center. There could be two magnets, one positioned at the vertical center and one at the bottom. There could be any number of magnets 808 so that they are spaced apart at a greater or lower distance.

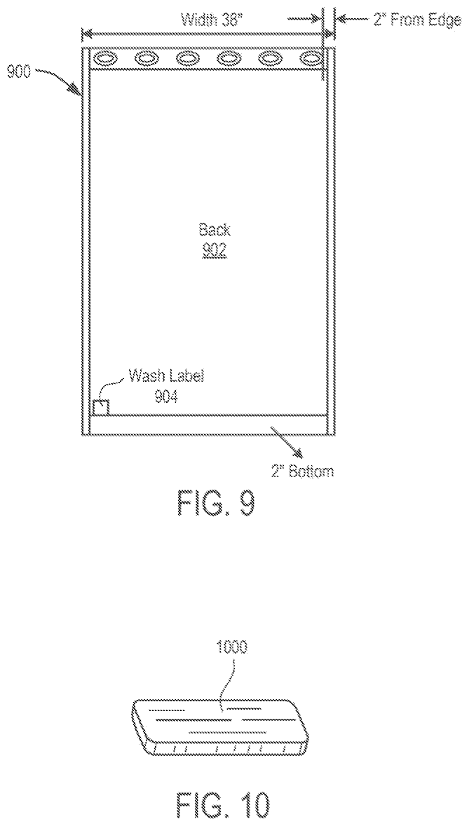

FIG. 9 illustrates a back side 902 of a panel 900 of a split curtain, in accordance with some embodiments. The backside 902 includes a wash label 904. In some embodiments, the backside includes backing. In some embodiments, the backing encases the magnets.

FIG. 10 illustrates a magnet 1000, in accordance with some embodiments. The magnet 1000 may be an example of magnet 708 and/or 808. The magnet 1000 may be sufficiently slim enough to fit within a leading edge hem of a panel. In some embodiments, the magnet 1000 is about 1″ in height, about ¼″ in width, and about ¼″ thick. In other embodiments, the magnet may be taller (e.g., 2″ in height) or shorter (e.g., ½″ or ¼″ in height), wider (e.g., ½″) or narrower, thicker (½″) or thinner (⅛″). Other dimensions are possible. In some embodiments, the magnet 1000 may be a rare earth magnet. In some embodiments, each magnet 1000 within the leading edge of a panel need not be identical.

Each magnet 1000 may be affixed to the panel using any attachment mechanism, e.g., glue, stitching, clips, clamps, placement into pockets, placement into enclosures that are affixed to the panels, etc. Each magnet 1000 may be visible on the backside of the panel or may be encased within a hem, backing, enclosure or covering.

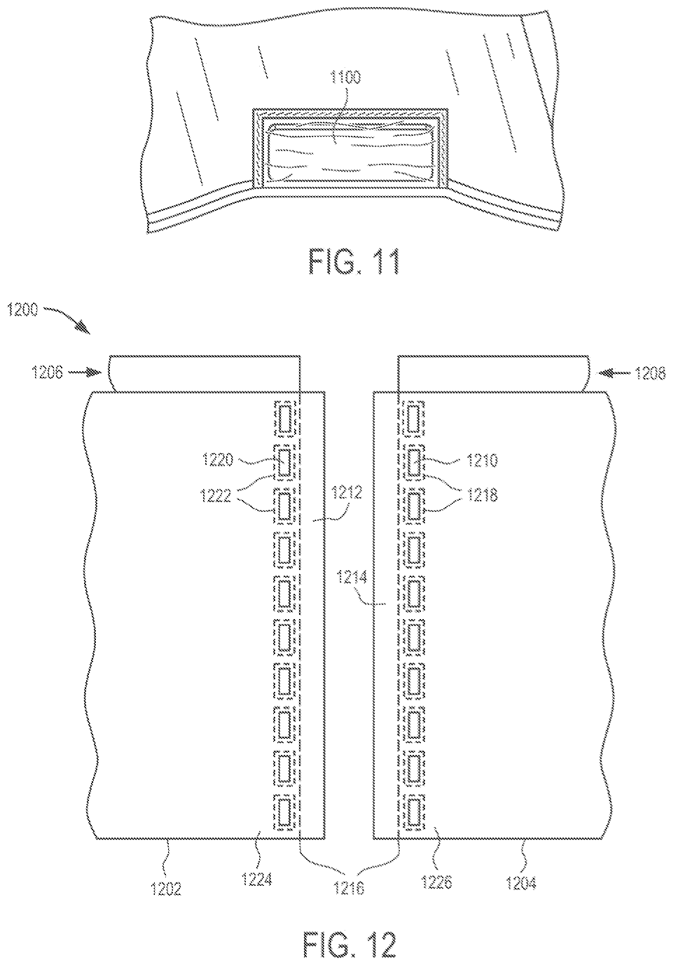

FIG. 11 illustrates an enclosure 1100 for receiving and/or enclosing a magnet 1000, in accordance with some embodiments. In some embodiments, the enclosure 1100 may made from plastic and/or rubber. In some embodiments, the enclosure 1100 may be made from any fabric. The enclosure 1100 may be used to affix the magnet 1000 to the curtain. The enclosure 1100 may be used to reduce or prevent moisture or water from contacting the magnet 1000. In some embodiments, the enclosure 1100 may be water tight. In some embodiments, the enclosure 1100 prevents water from contacting the magnet 1000 during a wash cycle. In some embodiments, the enclosure 1100 is a pocket to enable a user to insert and remove a magnet 1000 therefrom, e.g., before washing. In some embodiments, the enclosure may have a retaining structure, e.g., button, glue, flap, or snap, to assist in retaining the magnet within the enclosure. In some embodiments, the enclosure 1100 may be visible on the backside of the leading edge of a panel.

FIG. 12 illustrates a split curtain 1200 during manufacture, in accordance with some embodiments. Split curtain 1200 includes a left panel 1202 and a right panel 1204. The left panel 1202 includes a left head portion 1206. The right panel 1204 includes a right head portion 1208. The left head portion 1206 and/or right head portion 1208 may include a rod pocket, grommets, cubicles, goblets, and/or other supporting mechanism. The left panel 1202 may include a column of magnets 1220 along its left leading edge 1224. Each of the magnets 1220 may be affixed to the left panel 1202 along the left leading edge 1224 by an attachment mechanism 1222, e.g., stitching, glue, clips, clamps and/or the enclosure 1100. The right panel 1204 may include a column of magnets 1210 along its right leading edge 1226. Each of the magnets 1210 may be affixed to the right panel 1204 along the right leading edge 1226 by an attachment mechanism 1218, e.g., stitching, glue, clips, clamps and/or the enclosure 1100. To support magnetic engagement, the left magnets 1220 may be positioned at left vertical positions that are substantially the same as the right vertical positions of the right magnets 1210.

In some embodiments, the left and right panels 1202 and 1204 may include left and right flaps 1214 and 1214, which can be folded rearwards and stitched to the back face to sandwich the magnets 1220 and 1210 within a vertical hem. In some embodiments, there may be no left and right flaps that sandwich the magnets 1220 and 1210.

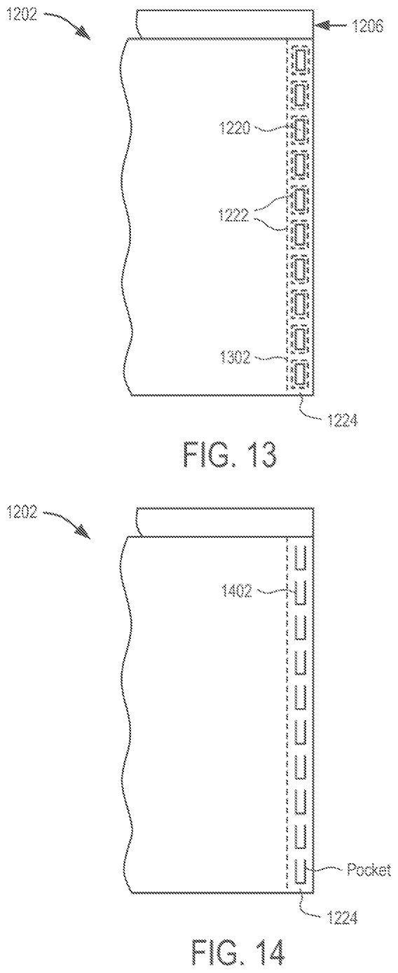

FIG. 13 illustrates a left panel 1202, in accordance with some embodiments. The left panel includes the column of magnets 1220 stitched within the left leading edge 1224 by stitching 1302. The right panel 1204 may be a mirror image of the left panel 1202.

FIG. 14 illustrates a left panel 1200 of a split curtain having a column of pockets 1402 along its left leading edge 1224, in accordance with some embodiments. Each pocket 1402 may be configured to receive a magnet 1000. In some embodiments, the pocket 1402 may be configure to remain open, so that the user can insert and remove magnets 1000 therefrom. In some embodiments, the use can reverse the magnetic pole direction of a column of magnets 1000 to change the engagement pattern from same side to overlapping. In some embodiments, the enclosure may have a retaining structure, e.g., button, glue, flap, or snap, to assist in retaining the magnet within the enclosure. In some embodiments, the pockets 1402 may include glue or a glued flap to enclose the magnet therein, possibly in a water-tight enclosure.

As indicated above, some split curtains may have three or more panels. Accordingly, middle panels may have magnets disposed along both its left and right leading edges so that each of the left and right leading edges cooperates with the adjacent panels.

Although the embodiments herein have been described using magnets, embodiments herein may use alternative panel-coupling devices, such as buttons, snaps, hook-and-loop fasteners, clips, and/or the like.

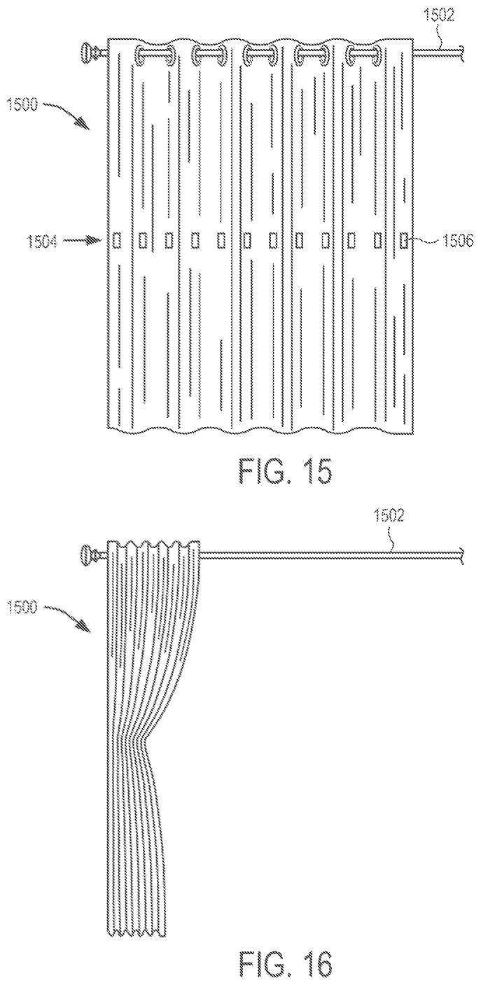

FIG. 15 illustrates a left panel 1500 suspended on a rod 1502 and in a closed position, in accordance with some embodiments. The left panel has magnets 1506 along a horizontal row 1504 to provide improved stacking when the left panel is maneuvered to an open position. The magnets 1506 may be disposed on the back face of the left panel 1500 or between the front face and a backing. The magnets 1506 may be within enclosures, e.g., enclosures 1100. In some embodiments, there may be two magnets 1506 within each pleat, e.g., at the ⅓ and ⅔ positions. The magnets 1506 may be disposed in a switching pattern of north and south poles so that the pleats bunch together to a tie back position.

FIG. 16 illustrates the left panel 1500 in an open position, in accordance with some embodiments. The magnets 1506 along the horizontal row 1504 engage with one another to generate the appearance of a tie back.

FIG. 17 illustrates bidirectional panels 1700A and 1700B, in accordance with some embodiments. The bidirectional panels 1700A and 1700B may be identical, so that either panel 1700A or 1700B can be used on the left side, on the right side, or in the center. As shown, the bidirectional panel 1700A includes a head portion 1702A, a column of magnets 1704A along the left edge 1706A and a column of magnets 1708A along a right edge 1710A. Similarly, the bidirectional panel 1700B includes a head portion 1702B, a column of magnets 1704B along the left edge 1706B and a column of magnets 1708B along a right edge 1710B. Accordingly, either panel 1700A or 1700B may have one or more leading edges and either panel 1700A or 1700B may be on the left, right or center. In some embodiments, the bidirectional panel 1700A includes a column of pockets (instead of magnets 1704A) along the left edge 1706A and a column of pockets (instead of magnets 1708A) along a right edge 1710A, and the bidirectional panel 1700B includes a column of pockets (instead of magnets 1704B) along the left edge 1706B and a column of pockets (instead of magnets 1708B) along a right edge 1710B. Magnets can be inserted into one or more of the pockets as needed, e.g., only on the leading edges or only in one or more selected pockets of the column of pockets on the leading edges.

The foregoing description of the preferred embodiments of the present invention is by way of example only, and other variations and modifications of the above-described embodiments and methods are possible in light of the foregoing teaching. The embodiments described herein are not intended to be exhaustive or limiting. The present invention is limited only by the following claims.

1. A split curtain, comprising:
a left fabric panel having a left-panel head portion configured to cooperate with a supporting structure and having a first left-panel leading edge;
a right fabric panel having a right-panel head portion configured to cooperate with the supporting structure and having a first right-panel leading edge, the first right-panel leading edge being configured to be brought into contact with the first left-panel leading edge;
a plurality of first left-panel magnets disposed along the first left-panel leading edge of the left fabric panel at first left-panel vertical positions, each first left-panel magnet disposed within a respective independent left-panel plastic or rubber enclosure, each first left-panel magnet being removable from the left panel before washing; and
a plurality of first right-panel magnets disposed along the first right-panel leading edge of the right fabric panel at first right-panel vertical positions, the first right-panel vertical positions being substantially the same as the first left-panel vertical positions, each first right-panel magnet disposed within a respective independent right-panel plastic or rubber enclosure, each first right-panel magnet being removable from the right panel before washing.

2. The split curtain of claim 1, wherein the plurality of first left-panel magnets and the plurality of first right-panel magnets are spaced apart by approximately 11″.

3. (canceled)

4. (canceled)

5. The split curtain of claim 1, wherein each respective right-panel plastic or rubber enclosure and respective left-panel plastic or rubber enclosure is water tight.

6. The split curtain of claim 1, wherein each respective independent right-panel plastic or rubber enclosure and respective independent left-panel plastic or rubber enclosure includes a pocket.

7. The split curtain of claim 6, wherein the pocket includes a retention structure.

8. The split curtain of claim 1, wherein the left-panel head portion and the right-panel head portion are parts of the same fabric.

9. The split curtain of claim 1, wherein the left-panel head portion and the right-panel head portion are individual portions.

10. The split curtain of claim 1, further comprising a third panel having a third-panel head portion, a third-panel leading edge, and a plurality of third-panel magnets disposed along the third-panel leading edge, the third-panel leading edge configured to cooperate with a second right-panel leading edge of the right panel, the right panel further having a plurality of second right-panel magnets disposed along the second right-panel leading edge.

11. The split curtain of claim 1, wherein the left fabric panel includes a plurality of second left-panel magnets on a second left-panel leading edge opposite the first left-panel leading edge, and the right fabric panel includes a plurality of second right-panel magnets on a second right-panel leading edge opposite the first right-panel leading edge.

12. A method, comprising:
maneuvering a left fabric panel and a right fabric panel to bring a left-panel leading edge of the left fabric panel into contact with a right-panel leading edge of the right fabric panel, the left fabric panel having a left-panel head portion configured to cooperate with a supporting structure and having a plurality of left-panel magnets disposed along the left-panel leading edge at left-panel vertical positions, each left-panel magnet disposed within a respective independent left-panel plastic or rubber enclosure, each left-panel magnet being removable from the left fabric panel before washing, the right fabric panel having a right-panel head portion configured to cooperate with the supporting structure and having a plurality of right-panel magnets disposed along the right-panel leading edge at right-panel vertical positions, the right-panel vertical positions being substantially the same as the left-panel vertical positions, each right-panel magnet disposed within a respective independent right-panel plastic or rubber enclosure, each right-panel magnet being removable from the right fabric panel before washing; and
maneuvering the plurality of left-panel magnets of the left panel at the left-panel vertical positions to contact the plurality of right-panel magnets of the right panel at the right-panel vertical positions, so that the plurality of left-panel magnets engage with the plurality of right-panel magnets.

13. A method comprising:
affixing a plurality of first left-panel magnets to a first left-panel leading edge of a left fabric panel at first left-panel vertical positions, the left fabric panel having a left-panel head portion configured to cooperate with a supporting structure, each first left-panel magnet disposed within a respective independent left-panel plastic or rubber enclosure, each first left-panel magnet being removable from the left panel before washing; and
affixing a plurality of first right-panel magnets to a first right-panel leading edge of a right fabric panel at first right-panel vertical positions, the first right-panel vertical positions being substantially the same as the first left-panel vertical positions, the right fabric panel having a right-panel head portion configured to cooperate with the supporting structure, each first right-panel magnet disposed within a respective independent right-panel plastic or rubber enclosure, each first right-panel magnet being removable from the right panel before washing, the first right-panel leading edge being configured to contact the first left-panel leading edge.

14. The method of claim 13, wherein the plurality of first left-panel magnets and the plurality of first right-panel magnets are spaced apart by approximately 11″.

15. (canceled)

16. (canceled)

17. The method of claim 13, wherein each respective independent right-panel plastic or rubber enclosure and respective independent left-panel plastic or rubber enclosure is water tight.

18. The method of claim 13, wherein each respective independent right-panel plastic or rubber enclosure and respective independent left-panel plastic or rubber enclosure includes a pocket.

19. The method of claim 18, wherein the pocket includes a retention structure.

20. The method of claim 13, wherein the left-panel head portion and the right-panel head portion are parts of the same fabric.

21. The method of claim 13, wherein the left-panel head portion and the right-panel head portion are individual portions.

22. The method of claim 13, further comprising
attaching a plurality of third-panel magnets along a third-panel leading edge of a third fabric panel having a third head portion; and
attaching a plurality of second right-panel magnets along a second right-panel leading edge of the right fabric panel, the third-panel leading edge of the third fabric panel configured to cooperate with the second right-panel leading edge of the right fabric panel.
